(19) United States
(12) Patent Application Publication
(10) Pub. No.: US 2007/0021518 A1
(43) Pub. Date: Jan. 25, 2007

(54) ADDITIVES TO SPRAY URETHANE

(75) Inventors: Glenn A. Cowelchuk, Chesterfield Township, MI (US); David Dooley, Troy, MI (US); Robert J. Adams, Ypsilanti, MI (US); Nelson E. Williams JR., Saline, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/161,058

(22) Filed: Jul. 21, 2005

(51) Int. Cl. C08G 18/00

(52) U.S. Cl. 521/170; 528/44

(57) ABSTRACT

A polyurethane resin includes polyol and isocyanate residues which together form a base resin. The polyurethane resin further includes a plurality of hollow beads dispersed therein such that the density of the polyurethane resin is less than the density of the base resin. A method for forming the polyurethane resin comprises mixing hollow beads the polyol and/or isocyanate prior to spraying onto a substrate.

### BACKGROUND OF THE INVENTION

1. Field of the Invention

The present invention relates to sprayed polyurethane resins that incorporate additives to reduce density.

2. Background Art

Skins for interior trim components provide a durable plastic cover for interior trim component structures and their associated foam padding. Currently, spray polyurethane processes are being developed for spray forming articles of manufacture, including interior trim assemblies that include such skin layers. Polyurethane is normally formed by mixing polyol and isocyanate in a spray gun or applicator mix head. Polyol and isocyanate are usually mixed just prior to dispensing or these components tend to react quickly thereby clogging such spray guns or applicator mix heads.

Products formed by polyurethane spray forming processes benefit from supplying additives to the polyol and isocyanate mixture. Examples of additives that increase the utility of polyurethane spray foam products include blowing agents for forming foam polyurethane, color concentrates for coloring the finished product, and cell opener polyol compounds that can soften the polyurethane. Standard polyurethane formulations that are used to form automobile interior components in particular often incorporate various additives to reduce the density of polyurethane skins. Such additives include blowing agents such as water and gases such as Freons, nitrogen, and carbon dioxide. The gases are normally injected into the chemical mixture at a mixing head. In contrast, water is typically blended into the chemical composition. The problem of adding only water as a primary blowing catalyst is that water reacts with the isocyanate that is present in polyurethane formulation to form polyurea molecules and carbon dioxide. Although these prior art processes work reasonably well, there is nevertheless continuing pressure to reduce the cost and weight of automobile components.

Accordingly, there exists a need for improved and more economical processes for forming polyurethane skin layers that are incorporated into automobile interior components.

### SUMMARY OF THE INVENTION

The present invention solves one or more problems of the prior art by providing in one embodiment a polyurethane resin. The polyurethane resin of this embodiment includes polyol and isocyanate residues which together form a base resin. The polyurethane resin further includes a plurality of hollow beads dispersed therein such that the density of the polyurethane resin is less than the density of the base resin. That is, the density of the polyurethane resin of this embodiment has lower density than the polyurethane that would be obtained if the hollow beads were not included. Accordingly, the inclusion of hollow beads in the present embodiment allows for the density to be tailored as desired.

In another embodiment, a method for making the polyurethane set forth above is provided. The method of this embodiment comprises independently spraying a polyol and an isocyanate onto a substrate. The polyol and isocyanate are sprayed is such a manner that mixing occurs prior to the components reacting to the substrate. Hollow beads are added to either the polyol and/or isocyanate prior to spraying. Typically, the high reactivity of the isocyanate makes it preferable to add the hollow beads to the polyol.

### BRIEF DESCRIPTION OF THE DRAWINGS

FIG. 1 is a cross-section of a skin layer made from the polyurethane resin of an embodiment of the invention; and

FIG. 2 is a schematic of an embodiment of an apparatus that is used to form a polyurethane resin of the invention.

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

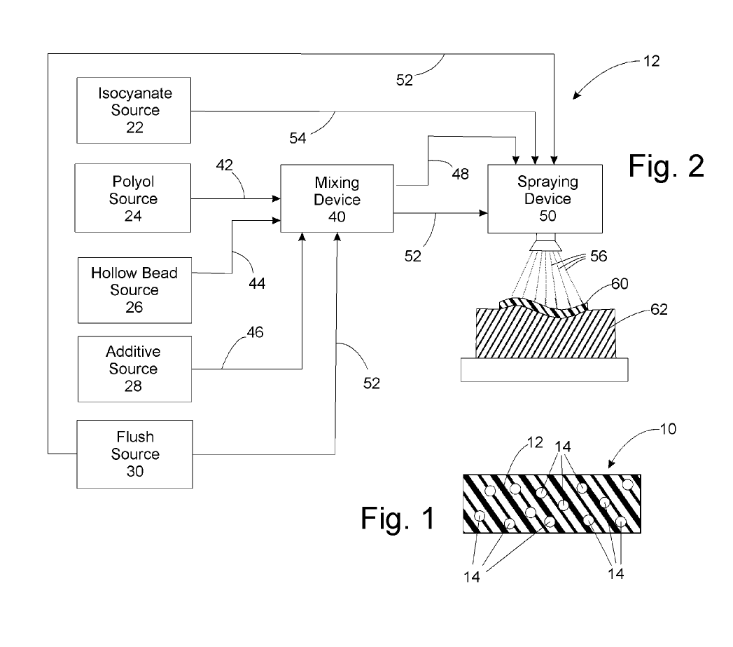

With reference to FIG. 1, a cross-section of a skin layer made from the polyurethane resin of an embodiment of the invention is provided. Polyurethane resin 10 includes residues of a polyol and residues of an isocyanate which together form base resin 12. As used herein, “base resin” refers to a polyurethane resin without any additives. Polyurethane resin 10 further includes a plurality of hollow beads 14 dispersed throughout polyurethane resin 10.

In the present embodiment, polyurethane resin 10 includes a sufficient amount of hollow beads 14 dispersed therein such that the density of polyurethane resin 10 is less than the density of the base resin alone. In some variations, the hollow beads are present in polyurethane resin 10 in such an amount that the density of polyurethane resin 10 is less than about 1 gram per cubic centimeter. In other variations, the hollow beads are present in polyurethane resin 10 in such an amount that the density of polyurethane resin 10 is from about 0.5 to about 1.0 grams per cubic centimeter. In still other variations of the invention, the hollow beads are present in polyurethane resin 10 in such an amount that the density of polyurethane resin 10 is from about 0.6 to about 0.9 grams per cubic centimeter. In still other variations of the invention, the hollow beads are present in polyurethane resin 10 in such an amount that the density of polyurethane resin 10 is from about 0.65 to about 0.85 grams per cubic centimeter. To achieve the desired density ranges in the present embodiment, hollow beads 14 are present in an amount from about 5% to about 90% of the total weight of the polyurethane resin. In another variation, hollow beads 14 are present in an amount from about 5% to about 70% of the total weight of the polyurethane resin. In still another variation, hollow beads 14 are present in an amount from about 10% to about 40% of the total weight of the polyurethane resin. In yet another variation, hollow beads 14 are present in an amount from about 10% to about 30% of the total weight of the polyurethane resin.

As set forth above, hollow beads are used in the present embodiment to advantageously adjust the density of polyurethane resin 10. The hollow beads are formed from any material that is able to withstand the temperature and chemical conditions present during formation of polyurethane resin 10. Ceramic, glass, and polymeric materials are particularly useful materials for the hollow beads. In some variations, the hollow beads are substantially spherical. The size of the hollow beads is such that a minimal amount of blemishes on visible surfaces of polyurethane resin 10 are observed. When the hollow beads are spherical, the hollow beads have an average diameter between about 5 and about 500 microns. In another variation, when the hollow beads are spherical, the hollow beads have an average diameter between about 5 and about 100 microns. In still other variations, when the hollow beads are spherical, the hollow beads have an average diameter between about 5 and about 50 microns. The density of the hollow beads is advantageously less than the density of base resin 12. This allows the average density of polyurethane 10 to be set at a value less than that of base resin 12. Typically, hollow beads 14 have an average density from about 0.5 to about 1.0 grams per cubic centimeter. An example of useful spherical hollow beads is the Spherical 60P18 glass beads commercially available form Potter Industries, Inc. These glass beads have an average density of 0.6 g per cubic centimeter and a mean diameter of about 18 microns.

With reference to FIG. 2, a schematic illustrating an apparatus for forming the polyurethane resin set forth above is provided. Apparatus 20 includes isocyanate source 22, polyol source 24 and optionally hollow bead source 26 and additive source 28, and flush source 30. Regarding isocyanate source 22, any suitable liquid isocyanate, such as an aromatic isocyanate, can be used. Examples of suitable aromatic liquid isocyanates include, but are not necessarily limited to, MDI and TDI. Alternatively, liquid aliphatic isocyanate could also be used. The liquid isocyanate may optionally include suitable additives, such as UV inhibitors/stabilizers, especially if the isocyanate is aromatic. Suitable suppliers of suitable liquid isocyanates include Huntsman of Auburn Hills, Mich.; Bayer Polymers of Pittsburgh, Pa.; and Dow Chemical of Freeport, Tex.

Still referring to FIG. 2, polyol source 24 includes any suitable liquid polyol. In at least one embodiment, the polyol employed is a polyether polyol. Examples of suitable liquid polyols include, but are not necessarily limited to, graft polyols, PhD polyols, Polymer Polyols, and PIPA polyols. Suitable suppliers of suitable liquid polyols include Dow Chemical of Freeport, Tex.; BASF Corporation of Wyandotte, Mich.; and Bayer Polymer of Pittsburgh, Pa. The liquid polyol could have suitable additives, especially if aliphatic, such as UV and antioxidant inhibitors/stabilizers, such as Irganox 1175, Tinuvin 765 and TIN B-75, from Ciba Specialty Chemicals of Terrytown, N.Y., and Cyasorb® Family UV stabilizers and antioxidants from Cytec Polymers of Stamford, Conn.

Apparatus 20 optionally includes mixing device 40. Mixing device 40 receives a stream 42 of polyol from the polyol source 24 and a predetermined amount of hollow beads from hollow bead source 26 via path 44. Additional additives are provided to mixing device 40 via stream 46. In the mixing device 40 the polyol and the hollow beads form a bead/polyol mixture in the form of bead/polyol stream 48 with any additional additives from stream 46 also being mixed in. Mixing device 40 provides sufficient agitation to disperse the hollow beads as well as mix in any additional additives. Alternatively, the hollow beads are added directly to polyol source 24 with sufficient agitation to disperse the hollow beads being provided.

As set forth above, apparatus 20 optionally includes additive source 28 for purging mixing device 40. Such additives may be any ingredient contained in the polyurethane formulation which is not directly added to isocyanate source 22 or polyol source 24. Such additives include, for example, colorants, blowing agents, UV inhibitors, and the like.

As set forth above, apparatus 20 optionally includes solvent flush source 30 for purging mixing device 40 and spraying device 50 via streams 52. Any suitable liquid solvent flush can be used for this purpose. Suitable solvent flushes include solvents that do not react with the isocyanate and polyol. Examples of suitable liquid solvent flushes include, but are not necessarily limited to MEK (methyl ethyl ketone), DBE (dibasic ester), NMP (Naptha) and mineral spirts, as are available from Ashland Chemical of Dublin, Ohio and Shell Oil Solvents of Kent, Ohio.

In at least one embodiment, spraying device 50 receives the bead/polyol stream 48 and isocyanate stream 54 from the mixing device 40 and the isocyanate source 22, respectively. Typically, spraying device 50 is a conventional spray gun. In this embodiment, the streams 48 and 54 mix in the spraying device 50 to form a liquid polyurethane composition 56 which is sprayed from the spraying device 50. When the hollow beads are added directly to polyol source 24 and there are no additional additives to be added, stream 42 may be provided to spraying device 50 instead of bead/polyol stream 48. Polyurethane composition 56 is directed towards spray mold 60 to form polyurethane skin 62. In some variations, polyurethane skin 62 has an average thickness of 0.6-1.5 mm. In another variation, polyurethane skin 62 has an average thickness of 0.8-1.2 mm.

In at least one embodiment, the polyol, isocyanate and any additional additives (from additive source 28) are maintained at elevated temperatures. In certain embodiments, the elevated temperatures are each independently 70-125° F., and in other embodiments 75-95° F. Each of the streams 88 and 92 may be provided at a pressure of between 600 psi and 2,000 psi to the spray device 60.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A polyurethane resin comprising:
residues of a polyol;
residues of an isocyanate; and
a plurality of hollow beads, wherein the residues of a polyol and the residues of an isocyanate are bonded to one another to form the polyurethane resin with the plurality of glass beads dispersed therein.

2. The polyurethane resin of claim 1 wherein the polyurethane resin has a sufficient amount of hollow glass beads dispersed therein so that the density of the polyurethane resin is less than about 1 g per cubic centimeter.

3. The polyurethane resin of claim 1 wherein the hollow beads comprise a material selected from glass, polymeric materials, and ceramic.

4. The polyurethane resin of claim 1 wherein the hollow beads have an average density from about 0.5 to about 1.0 grams per cubic centimeter.

5. The polyurethane resin of claim 1 wherein the hollow beads are substantially spherical.

6. The polyurethane resin of claim 5 wherein the hollow beads have an average diameter between about 5 and about 500 microns.

7. The polyurethane resin of claim 5 wherein the hollow beads have an average diameter between about 5 and about 100 microns.

8. The polyurethane resin of claim 5 wherein the hollow beads have an average diameter between about 5 and about 50 microns.

9. The polyurethane resin of claim 1 made by the method comprising:
combining a polyol with a plurality of glass, polymeric, or ceramic beads to form a polyol-bead mixture;
reacting the polyol with an isocyanate to form the polyurethane resin.

10. The polyurethane resin of claim 9 wherein the polyol-bead mixture and the isocyanate are each sprayed onto a surface such that the polyol-bead mixture and the isocyanate react to form the polyurethane resin.

11. A polyurethane resin comprising:
residues of a polyol;
residues of an isocyanate; and
a plurality of hollow spherical glass beads, wherein the residues of a polyol and the residues of an isocyanate are bonded to one another to form the polyurethane resin with the plurality of hollow spherical glass beads dispersed therein.

12. The polyurethane resin of claim 11 wherein the polyurethane resin has a sufficient amount of hollow spherical glass beads dispersed therein so that the density of the polyurethane resin is less than about 1 g per cubic centimeter.

13. The polyurethane resin of claim 11 wherein the hollow spherical glass beads comprise a material selected from glass, polymeric materials, and ceramic.

14. The polyurethane resin of claim 11 wherein the hollow spherical glass beads have an average density from about 0.5 to about 1.0 grams per cubic centimeter.

15. The polyurethane resin of claim 11 wherein the hollow spherical glass beads have an average diameter between about 5 and about 500 microns.

16. The polyurethane resin of claim 11 wherein the hollow spherical glass beads have an average diameter between about 5 and about 100 microns.

17. The polyurethane resin of claim 11 wherein the hollow spherical glass beads have an average diameter between about 5 and about 50 microns.

18. The polyurethane resin of claim 11 made by the method comprising:
combining a polyol with a plurality of hollow spherical glass beads to form a polyol-bead mixture;
reacting the polyol with an isocyanate to form the polyurethane resin.

19. The polyurethane resin of claim 18 wherein the polyol-bead mixture and the isocyanate are each sprayed onto a surface such that the polyol-bead mixture and the isocyanate react to form the polyurethane resin.

20. A skin layer comprising the polyurethane resin of claim 15.
